(19) United States
(12) Patent Application Publication
(10) Pub. No.: US 2024/0327672 A1
(43) Pub. Date: Oct. 3, 2024

(54) METHOD FOR RESTORING PROTECTING FILM FOR VEHICLE

(71) Applicant: STEK CO., LTD., Seoul (KR)

(72) Inventors: Beckyoun Noh, Seongnam-si (KR); Inhwan Oh, Seoul (KR)

(21) Appl. No.: 18/137,055

(22) Filed: Jun. 7, 2023

(30) Foreign Application Priority Data
Mar. 30, 2023 (KR) 10-2023-0042109

(51) Int. Cl. C09D 183/16; C09D 1/00; C09D 7/20; C09D 7/65

(52) U.S. Cl. CPC C09D 183/16; C09D 1/00; C09D 7/20; C09D 7/65

(57) ABSTRACT

The present invention relates to a method for a protecting film for a vehicle, and when a surface damage is generated after installing the protecting film on a painted surface of the vehicle, the surface is polished using a compound composition containing a lubricant having an evaporation point of 150° C. or higher and then the surface is coated using a restoration coating composition containing a polar solvent, so as to restore the vehicle protecting film having the damaged surface without replacing the vehicle protecting film.

### BACKGROUND OF THE INVENTION

### 1. Field of the Invention

The present invention relates to a method for a protecting film for a vehicle, and when a surface damage is generated after installing the protecting film on a painted surface of the vehicle, the surface is polished using a compound composition containing a lubricant having an evaporation point of 150° C. or higher and then the surface is coated using a restoration coating composition containing a polar solvent, so as to restore the vehicle protecting film having the damaged surface without replacing the vehicle protecting film.

### 2. Description of the Related Art

Expensive vehicles need relatively meticulous maintenance, and most vehicles have a vehicle protecting film attached thereto. The vehicle protecting film may correspond to a wrapping film, PPF, or the like.

Since the vehicle protecting film has a relatively short history compared to vehicle painting and is only used in some vehicles, there is a lack of solutions for managing the vehicle protecting film. Accordingly, when damages such as water spots or scratches are generated on the vehicle protecting film, the damaged vehicle protecting film is removed and then re-installed. However, this causes the problem in that the installation cost for the vehicle protecting film may amount to several million Korean Won to tens of thousands of Korean Won, thereby returning to the burden of a consumer.

Recently, in order to improve the above problem, schemes of applying a compound onto a surface of a damaged vehicle protecting film and polishing the surface by using a pad have been attempted. However, the vehicle protecting film has a surface friction relatively high compared to a painted surface of the vehicle, so a lot of heat is generated during polishing work, and the vehicle protecting film is formed of a constituent material, such as TPU, which is vulnerable to heat compared to the painted surface of the vehicle, and thus the surface of the vehicle protecting film is burned or damaged due to the vulnerability to heat.

In addition, when a surface layer of the vehicle protecting film is a clear coat, and when polishing is repeatedly performed using a compound, the clear coat may be weakened to lower UV blocking performance, resulting in discoloration, or a base coat positioned on a lower side of the clear coat may be exposed to the outside and damaged.

In other words, there is an urgent need to develop a compound composition for restoring the surface of a vehicle protecting film to a state before the damage without damaging the vehicle protecting film and without rebuilding entirely or partially.

### SUMMARY OF THE INVENTION

An object of the present invention is to provide a method for a protecting film for a vehicle, when a surface damage is generated after installing the protecting film on a painted surface of the vehicle, the surface is polished using a compound composition containing a lubricant having an evaporation point of 150° C. or higher and then the surface is coated using a restoration coating composition containing a polar solvent, so as to restore the vehicle protecting film having the damaged surface without replacing the vehicle protecting film.

In order to solve the above problem, one embodiment of the present invention provides a method for restoring a vehicle protecting film having a damage on an upper side and including a self-restoration layer, which includes: a gloss solution step of applying a compound composition to the self-restoration layer of the vehicle protecting film and then polishing an upper side of the self-restoration layer by a predetermined thickness using a pad, thereby removing the damage; and a coating solution step of forming a restoration coating layer by a predetermined thickness by applying a restoration coating composition on the upper side of the self-restoration layer from which damage is removed through the gloss solution step, wherein the gloss solution step and the coating solution step are performed, so that the vehicle protecting film is restored without separately replacing the vehicle protecting film.

In some embodiments of the invention, in the gloss solution step and when the upper side of the self-restoration layer is polished, the upper side of the self-restoration layer may be polished by a thickness corresponding to a depth of the damage generated in the self-restoration layer or greater than the depth of the damage, and in the coating solution step and when the restoration coating composition is applied, the restoration coating composition may be applied as much as the thickness of the self-restoration layer polished through the gloss solution step.

In some embodiments of the invention, the gloss solution step may include: a first compound polishing step of applying a first compound composition on an upper surface of the self-restoration layer, polishing the upper surface using a first polishing pad by a thickness corresponding to the depth of the damage generated in to the upper surface or greater than the depth of the damage; and a second compound polishing step of applying a second compound composition to the upper surface polished through the first compound polishing step, and polishing the upper surface by using a second polishing pad, wherein the first compound composition may include an abrasive having a particle size larger than a particle size of the second compound composition.

In some embodiments of the invention, in the first compound polishing step, the upper surface of the self-restoration layer may be polished by rotating the first polishing pad at 1500 rpm to 2000 rpm for 1 seconds to 30 seconds, and in the second compound polishing step, the upper surface of the self-restoration layer may be polished by rotating the second polishing pad at 600 rpm to 1000 rpm for 1 seconds to 30 seconds.

In some embodiments of the invention, the restoration coating composition may include: a polar solvent including any one of acetone, isopropyl alcohol (IPA), methyl isobutyl ketone (MIBK), and ethyl acetate (EA); a non-metallic material including any one of SiO2 and polysilazane; an additive including a first silicone, a second silicone, and a solvent; and a non-polar solvent.

In some embodiments of the invention, the restoration coating composition may include: 10 wt % to 20 wt % of a polar solvent; 50 wt % to 70 wt % of a non-metallic material; 10 wt % to 50 wt % of an additive; and 5 wt % to 15 wt % of a non-polar solvent, based on a total weight.

One embodiment of the present invention provides a restoration solution in which the surface is polished using a compound composition containing a lubricant having an evaporation point of 150° C. or higher and then the surface is coated using a restoration coating composition containing a polar solvent, so that the damaged vehicle protecting film can be restored without replacing the vehicle protecting film.

According to one embodiment of the present invention, a non-glossy phenomenon confirmed with a naked eye may be removed by primarily removing a damage such as a scratch formed on a surface by polishing and then secondarily removing scratches generated due to polishing work by additionally polishing, so that a gloss of the vehicle protecting film can be restored only by the polishing work.

According to one embodiment of the present invention, a restoration coating layer is formed on the self-restoration layer of the vehicle protecting film after the polishing work, thereby preventing the self-restoration layer of the vehicle protecting film from being exposed to the outside due to the polishing work and lowering performance, so that restoration completion can be improved.

According to one embodiment of the present invention, the restoration coating layer is formed on the surface of the vehicle protecting film damaged by the thickness polished through the gloss solution step, so that the phenomenon, in which the thickness of the vehicle protecting film is reduced due to the polishing work and the protective performance of the film is lowered, can be prevented.

According to one embodiment of the present invention, the polar solvent is added to the restoration coating composition, thereby improving the adhesion between the restoration coating composition and the vehicle protecting film when the restoration coating layer is formed on the surface of the self-restoration layer of the vehicle protecting film, so that coating completion can be improved.

According to one embodiment of the present invention, a relatively high content of the non-metallic material is added to the restoration coating composition, so that the restoration coating layer having a thickness equal to a thickness of the vehicle protecting film polished through polishing work can be formed.

According to one embodiment of the present invention, water is used as a solvent for the compound composition in considering that the surface temperature of the vehicle protecting film during polishing work is about 90° C., so that the compound composition can be evaporated at an appropriate rate during the polishing work.

According to one embodiment of the present invention, a lubricant having an evaporation point of 150° C. or higher is added to the compound composition, and accordingly, the compound composition may remain on the surface of the vehicle protecting film even during polishing work, so that the surface of the vehicle protecting film can be prevented from being damaged.

According to one embodiment of the present invention, the compound composition includes an abrasive having a specific particle size so as to evenly polish the surface of the vehicle protecting film, so that the completion of the polishing work can be improved.

According to one embodiment of the present invention, a combination of a first lubricant having an oil evaporation point of 150° C. and a second lubricant having an oil evaporation point of 250° C. is added to the compound composition, so that the vehicle protecting film can be more effectively restored.

According to one embodiment of the present invention, the compound composition includes a second lubricant having an oil evaporation point of 200° C. or higher so as to be used stably even when being left in heat generated for a long time during the polishing work, so that the vehicle protecting film can be managed, such as polishing, without a damage on the surface.

### BRIEF DESCRIPTION OF THE DRAWINGS

FIGS. 1A, 1B and 1C show states in which damages occur to a vehicle protecting film as an example.

FIG. 2 schematically shows detailed steps of a method for restoring a vehicle protecting film according to one embodiment of the present invention.

FIG. 3 schematically shows detailed steps of the gloss solution step according to one embodiment of the present invention.

FIGS. 4A, 4B, 4C and 4D conceptually show a restoration solution for a vehicle protecting film using a compound composition according to one embodiment of the present invention.

FIGS. 5A, 5B and 5C schematically show a state in which the method for restoring the vehicle protecting film according to one embodiment of the present invention is performed.

FIGS. 6A, 6B, 6C, 6D and 6E schematically show a first polishing pad and a second polishing pad according to one embodiment of the present invention.

FIGS. 7A and 7B schematically show a state in which the gloss solution step is performed using a dedicated wool pad according to one embodiment of the present invention.

FIGS. 8A and 8B schematically show states in which the vehicle protecting film is polished using a conventional compound.

FIGS. 9A, 9B, 9C and 9D schematically show results on test #1 of polishing the compound composition according to one embodiment of the present invention.

FIGS. 10A, 10B, 10C and 10D schematically show results on test #2 of polishing the compound composition according to one embodiment of the present invention.

FIGS. 11A, 11B, 11C and 11D schematically show results on test #3 of polishing the compound composition according to one embodiment of the present invention.

FIG. 12 schematically shows a state in which the vehicle protecting film is restored using the compound composition according to one embodiment of the present invention.

FIGS. 13A, 13B, 13C and 13D schematically show details of a coating test of the restoration coating composition according to one embodiment of the present invention.

FIGS. 14A and 14B schematically show a state in which the vehicle protecting film formed with a restoration coating layer according to one embodiment of the present invention is restored.

### DETAILED DESCRIPTION OF THE INVENTION

Hereinafter, various embodiments and/or aspects will be described with reference to the drawings. In the following description, numerous specific details are set forth in order to provide a thorough understanding of one or more aspects for the purpose of explanation. However, it will also be appreciated by a person having ordinary skill in the art that such aspect (s) may be carried out without the specific details. The following description and accompanying drawings will be set forth in detail for specific illustrative aspects among one or more aspects. However, the aspects are merely illustrative and some of various ways among principles of the various aspects may be employed, and the descriptions set forth herein are intended to include all the various aspects and equivalents thereof.

The term “embodiment”, “example”, “aspect”, “exemplification”, or the like as used herein may not be construed in that an aspect or design set forth herein is preferable or advantageous than other aspects or designs.

Further, the term “or” is intended to signify an inclusive “or” rather than an exclusive “or”. In other words, unless otherwise specified or contextually unclear, the expression “X uses A or B” is intended to signify one of natural inclusive substitutions. In other words, when X uses A; X uses B; or X uses both A and B, the expression “X uses A or B” may apply to either of the above cases. In addition, it is apparent to be understood that the term “and/or” as used herein refers to and includes all possible combinations of one or more among related items listed.

In addition, the terms “include” and/or “comprise” specify the presence of the corresponding feature and/or component, but do not preclude the possibility of the presence or addition of one or more other features, components or combinations thereof.

In addition, it will be understood that singular expressions such as “one” and “the”, unless explicitly indicated otherwise in this specification, include plural expressions. Accordingly, for example, “component surface” includes one or more component surfaces.

In addition, the terms including an ordinal number such as first and second may be used to describe various elements, however, the components are not limited by the terms. The terms are used only for the purpose of distinguishing one component from another component. For example, the first component may be referred to as the second component without departing from the scope of the present invention, and similarly, the second component may also be referred to as the first component. The term “and/or” includes any one of a plurality of related listed items or a combination thereof.

In addition, the term used herein is merely for the purpose of illustrating a particular embodiment, and it is not intended to limit the present invention. The singular expression includes a plural expression unless the context clearly means otherwise. In the specification herein, it will be understood that the term such as “include” and “have” is intended to designate the presence of feature, number, step, operation, element, component, or a combination thereof recited in the specification, which does not preclude the possibility of the presence or addition of one or more other features, numbers, steps, operations, elements, components, or combinations thereof.

In addition, in embodiments of the present invention, unless defined otherwise, all terms used herein including technical or scientific terms have the same meaning as commonly understood by a person having ordinary skill in the art. Terms such as those defined in generally used dictionaries will be interpreted to have the meaning consistent with the meaning in the context of the related art, and will not be interpreted as an ideal or excessively formal meaning unless expressly defined in the embodiment of the present invention.

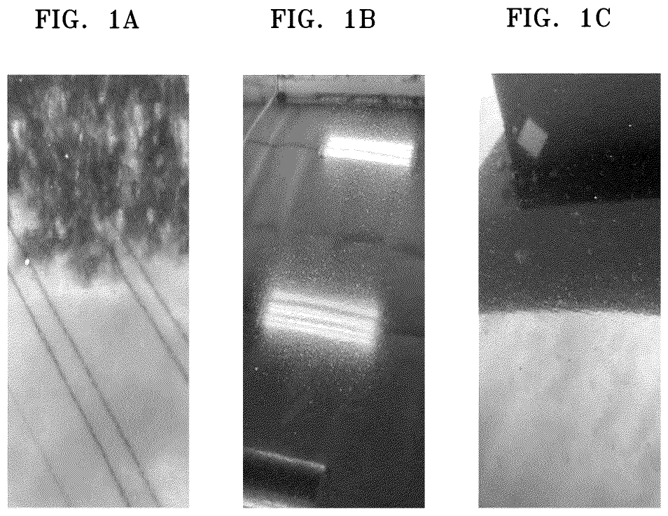

FIGS. 1A and 1B show states in which damages occur to a vehicle protecting film as an example.

The vehicular protecting film may correspond to a wrapping film, PPF, or the like.

After the vehicle protecting film is installed on the vehicle, the vehicle protecting film (hereinafter, the vehicle protecting film) may have a surface in which damages such as water spots or scratches as shown in FIGS. 1A, 1B, and 1C are generated depending on usage environments.

Since there is not a managing solution specialized for a vehicle protecting film in the related art, the damaged vehicle protecting film is removed and re-installed to remove the damage, however, as a result, the burden on consumers has been gradually increased. Recently, schemes of applying a compound to a surface of a vehicle protecting film and then polishing the surface by using a pad have been attempted to reduce the burden on consumers.

In general, heat generated during the polishing work may increase a surface temperature of the vehicle protecting film to 85° C. to 95° C., and the vehicle protecting film has a self-restoration layer that is vulnerable to heat. Although the compound is required to be prevented from being evaporated during polishing work to protect the self-restoration layer, the conventional compounds are evaporated too quickly during the polishing work, and accordingly, only the abrasive ingredients remain, thereby causing a damage to the self-restoration layer.

In other words, in order to polish the surface of the vehicle protecting film using a compound to remove the damage, it is necessary to use a compound composition capable of protecting a self-restoration layer vehicle protecting film from heat generated during polishing work. In addition, since an inner layer of the vehicle protecting film may be exposed to the outside after polishing the surface of the vehicle protecting film, the inner layer is required be coated.

According to the present invention in order to solve the above-described problems in the related art, a surface of a vehicle protecting film is polished using a compound composition to which a lubricant having an evaporation point of 150° C. or higher is added, and then the surface of the polished vehicle protecting film is coated a using restoration coating composition to which a polar solvent is added.

More particularly, the present invention relates to a method for a protecting film for a vehicle, which includes the steps of, as a whole: polishing the surface of the vehicle protecting film; and coating the polished surface of the vehicle protecting film. In the step of polishing the surface of the vehicle protecting film, a compound composition composed of an abrasive, a lubricant, and a solvent for restoring the vehicle protecting film is applied to the surface of the vehicle protecting film and then polishing with a pad, wherein the lubricant has a feature of having an evaporation point of 150° C. or higher. In the step of coating the surface of the vehicle protecting film, a coating layer is formed by applying a restoration coating composition composed of a polar solvent, a non-polar solvent, and a non-metallic material to the polished surface of the vehicle protecting film, wherein the coating layer has a feature of being formed to have a thickness equal to the polished thickness.

Due to the features, according to the method for the vehicle protecting film of the present invention, the compound composition may remain on the surface of the vehicle protecting film even during polishing work, so that the surface of the vehicle protecting film can be prevented from being damaged, and the surface of the vehicle protecting film may be coated after the polishing work, so that performance deterioration can be prevented.

In other words, the present invention provides a restoration solution in which the surface is polished using a compound composition containing a lubricant having an evaporation point of 150° C. or higher and then the surface is coated using a restoration coating composition containing a polar solvent, so that the damaged vehicle protecting film can be restored without replacing the vehicle protecting film.

Hereinafter, the method for the vehicle protecting film (hereafter, referred to as “restoration solution”) according to one embodiment of the present invention will be described in detail.

### Restoration Solution

The present invention provides a restoration solution for restoring a vehicle protecting film damaged on an upper side and including a self-restoration layer without separately replacing the vehicle protecting film. The restoration solution of the present invention polishes the upper side of the self-restoration layer by using the compound composition applied to the self-restoration layer and a polisher rotating in a circular manner.

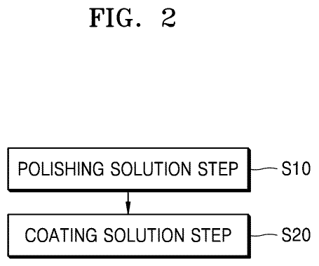

FIG. 2 schematically shows detailed steps of a method for restoring a vehicle protecting film according to one embodiment of the present invention.

The method for restoring a vehicle protecting film having a damage on an upper side and including a self-restoration layer according to one embodiment of the present invention includes: a gloss solution step (S10) of applying a compound composition to the self-restoration layer of the vehicle protecting film and then polishing an upper side of the self-restoration layer by a predetermined thickness using a pad, thereby removing the damage; and a coating solution step (S20) of forming a restoration coating layer by a predetermined thickness by applying a restoration coating composition on the upper side of the self-restoration layer from which damage is removed through the gloss solution step (S10).

In the above configuration, the restoration solution according to one embodiment of the present invention can restore the vehicle protecting film without separately replacing the vehicle protecting film by performing the gloss solution step (S10) and the coating solution step (S20).

The gloss solution step (S10) corresponds to a step of removing a damage generated on the upper side of the vehicle protecting film, and the surface of the vehicle protecting film may be polished to a depth corresponding to the damage. The vehicle protecting film corresponds to a vehicle protecting film in which a self-restoration layer is formed on the uppermost layer in one embodiment of the present invention, and the self-restoration layer corresponds to a polyurethane material.

Preferably, in the gloss solution step (S10), when the upper side of the self-restoration layer is polished, the upper side of the self-restoration layer may be polished by a thickness corresponding to a depth of the damage generated in the self-restoration layer or greater than the depth of the damage.

The related art uses a compound evaporated quickly during the polishing process as described above. Thus, a compound-related technology has been developed for the purpose of removing a damage generated on a surface of a vehicle protecting film without damaging the vehicle protecting film.

However, in this case, another scratch may occur during the polishing work. However, since the scratch penetrates a self-restoration layer at a relatively shallow depth compared to the damage, and there are compound-related technical problems, further work for removing the scratch has not been performed.

Meanwhile, since the scratch generated by the polishing work may cause a non-glossy phenomenon on the surface of the vehicle protecting film. Thus, according to the present invention, polishing work for removing a damage formed on the surface of the vehicle protecting film is performed and then an additional work for removing a scratch generated in the polishing work is performed. Preferably, the gloss solution step (S10) corresponds to a two-step polishing work in which the damage generated on the upper side of the self-restoration layer of the vehicle protecting film is primarily polished, and the scratch generated by the above polishing is secondarily polished.

As above, in one embodiment of the invention, the non-glossy phenomenon confirmed with a naked eye may be removed by primarily removing a damage such as a scratch formed on a surface by polishing and then secondarily removing scratches generated due to polishing work by additionally polishing, so that a gloss of the vehicle protecting film can be restored only by the polishing work.

Detailed steps of the gloss solution step (S10) will be described in detail through the drawings described later.

Meanwhile, in the gloss solution step (S10), a compound composition composed of special ingredients may be applied and the surface of the vehicle protecting film may be polished using a polishing pad.

The compound composition and the polishing pad will be described in detail through the drawings described later.

The coating solution step (S20) corresponds to a step of forming a restoration coating layer on the surface of the vehicle protecting film to prevent the upper side of the polished vehicle protecting film from being exposed to the outside, and the restoration coating layer has a thickness corresponding to a thickness of the vehicle protecting film polished through the gloss solution step (S10).

Preferably, when the restoration coating composition is applied, the restoration coating composition may be applied as much as the thickness of the self-restoration layer polished through the gloss solution step (S10).

Thus, the restoration coating layer is formed on the self-restoration layer of the vehicle protecting film after the polishing work, thereby preventing the self-restoration layer of the vehicle protecting film from being exposed to the outside due to the polishing work and lowering performance, so that restoration completion can be improved.

Meanwhile, in the case of the vehicle protecting film in which the damage is remove by polishing the surface, the thickness of the self-restoration layer, which is the uppermost layer of the vehicle protecting film, is removed during the polishing work by a thickness corresponding to the depth of the damage. In this case, it is difficult to exhibit all the performance at the time of initial installation since the overall thickness of the vehicle protecting film is reduced. More particularly, the self-restoration layer may fail to restore the scratch generated on the surface to have the performance at the time of initial installation, or the vehicle protecting film may be entirely damaged by an external impact.

These problems have been recognized in the related art and a coating layer is formed by applying a coating composition to the surface of the self-restoration layer of the polished vehicle protecting film. However, the inside of the self-restoration layer is exposed to the outside, and a slip additive included in the coating layer interferes with the coating layer from adhering to the surface of the self-restoration layer, and accordingly, the adhesion with the coating layer is lowered. As a result, it is substantially limited to temporarily coating the surface of the polished vehicle protecting film.

According to the present invention, a restoration coating composition composed of special ingredients is applied to the polished surface of the self-restoration layer of the vehicle protecting film to form a restoration coating layer, and the ingredients of the restoration coating composition increases the adhesion between the restoration coating composition and the self-restoration layer, so that the restoration coating layer can be stably formed and maintained.

In other words, in one embodiment of the invention, when the restoration coating layer is formed the adhesion between the restoration coating composition and the vehicle protecting film is improved, so that coating completion can be improved.

In addition, since the conventional coating composition cannot form a coating layer having a polished thickness of the vehicle protecting film, the overall thickness of the vehicle protecting film becomes thinner after polishing work.

The present invention uses a restoration coating composition composed of special ingredients, so as to form a restoration coating layer having a thickness corresponding to the thickness removed by polishing on the surface of the self-restoration layer of the vehicle protecting film, so that the initial thickness of the vehicle protecting film can be maintained even after polishing.

In other words, in one embodiment of the invention, the restoration coating layer is formed on the surface of the vehicle protecting film damaged by the thickness polished through the gloss solution step (S10), so that the phenomenon, in which the thickness of the vehicle protecting film is reduced due to the polishing work and the protective performance of the film is lowered, can be prevented.

The restoration coating composition will be described in detail through the drawings described later.

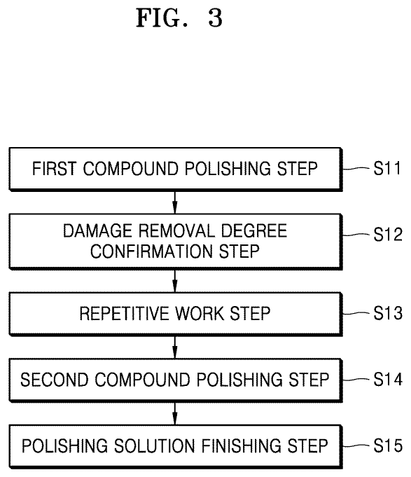

FIG. 3 schematically shows detailed steps of the gloss solution step (S10) according to one embodiment of the present invention.

The gloss solution step (S10) according to one embodiment of the present invention may include: a first compound polishing step (S11) of applying a first compound composition on an upper surface of the self-restoration layer, and polishing the upper surface by a thickness corresponding to the depth of the damage generated in to the upper surface or greater than the depth of the damage by using a first polishing pad; and a second compound polishing step (S14) of applying a second compound composition to the upper surface polished through the first compound polishing step (S11), and polishing the upper surface by using a second polishing pad.

The first compound polishing step (S11) corresponds to a step of directly removing a damage generated on the upper side of the vehicle protecting film.

In the first compound polishing step (S11), the surface of the vehicle protecting film is polished using a compound composition formed of a combination described below. Preferably, a first compound composition may be applied to the surface of the self-restoration layer of the vehicle protecting film, and the surface of the vehicle protecting film may be buffed and polished using a first polishing pad. The first compound composition may be preferably applied in a predetermined amount, and the amount corresponds to an amount capable of maintaining a surface temperature of 85° C. to 95° C. of the vehicle protecting film during polishing work.

The first compound composition will be described in detail through the drawings described later.

Meanwhile, in the first compound polishing step (S11), the upper surface of the self-restoration layer may be polished by rotating the first polishing pad at 1500 rpm to 2000 rpm for 1 seconds to 30 seconds. It may be preferable that the 1500 rpm to 2000 rpm corresponds to any one of a rotational speed rotated by the single-type polisher described later outputted at 55% to 65% of the maximum power, and a rotational speed rotated by the dual-type polisher described later outputted at 85% to 95% of the maximum power, and the 1 seconds to 30 seconds correspond to a time during which the surface temperature of the vehicle protecting film maintains at 85° C. to 95° C. during the polishing work.

The first polishing pad will be described in detail through the drawings described later.

The second compound polishing step (S14) corresponds to a step of removing a scratch generated while performing the first compound polishing step (S11).

As described above, a scratch may occur due to abrasive particles included in the compound composition in the process of removing the damage generated on the upper side of the vehicle protecting film. Thus, according to the present invention, the second compound polishing step (S14) is performed to polish the surface of the polished vehicle protecting film. Preferably, a second compound composition may be applied to the surface of the self-restoration layer of the polished vehicle protecting film, and the surface of the vehicle protecting film may be buffed and polished using a second polishing pad. The second compound composition may be preferably applied in a predetermined amount, and the amount corresponds to an amount capable of maintaining a surface temperature of 85° C. to 95° C. of the vehicle protecting film during polishing work.

In one embodiment of the invention, the first compound composition may preferably include an abrasive having a larger particle size compared to the second compound composition.

The second compound composition will be described in detail through the drawings described later.

Meanwhile, in the second compound polishing step (S14), the upper surface of the self-restoration layer may be polished by rotating the second polishing pad at 600 rpm to 1000 rpm for 1 seconds to 30 seconds. It may be preferable that the 600 rpm to 1000 rpm corresponds to a lower rotational speed compared to the first polishing pad, and the 1 seconds to 30 seconds correspond to a time during which the surface temperature of the vehicle protecting film maintains at 85° C. to 95° C. during the polishing work.

The second polishing pad will be described in detail through the drawings described later.

Meanwhile, in the gloss solution step (S10) as shown in FIG. 3, a damage removal degree confirmation step (S12) may be performed after the first compound polishing step (S11) is performed.

The damage removal degree confirmation step (S12) corresponds to a step of confirming whether the damage on the surface of the vehicle protecting film is entirely removed after the first compound polishing step (S11) is performed. In one embodiment of the invention, in the damage removal degree confirmation step (S12), the surface of the self-restoration layer of the vehicle protecting film may be wiped using alcohol-type chemicals after the first compound polishing step (S11) is performed, so as to confirm whether the damage to the surface is removed.

When it is confirmed that the damage of the surface is not removed in the damage removal degree confirmation step (S12), a repetitive work step (S13) of repeatedly performing the first compound polishing step (S11) and the damage removal degree confirmation step (S12) may be performed. The repetitive work step (S13) may be preferably performed repeatedly until the damage to the surface of the self-restoration layer of the vehicle protecting film is entirely removed when confirmed with the naked eye.

In addition, in the gloss solution step (S10) as shown in FIG. 3, a gloss solution finishing step (S15) may be performed after the second compound polishing step (S14) is performed.

In the polishing solution finishing step (S15), the surface of the polished self-restoration layer of the vehicle protecting film may be wiped using alcohol-type chemicals, and impurities may be removed so that the restoration coating composition may be applied to the surface of the self-restoration layer of the vehicle protecting film.

In other words, the second compound polishing step (S14) does not repeatedly work unlike the first compound polishing step (S11). However, when there is an area in which some gloss is not restored, it may be preferable to work repeatedly only on the corresponding area.

As above, in one embodiment of the invention, a non-glossy phenomenon confirmed with the naked eye may be removed by primarily removing a damage such as a scratch formed on a surface by polishing and then secondarily removing scratches generated due to polishing work by additionally polishing, so that a gloss of the vehicle protecting film can be restored only by the polishing work.

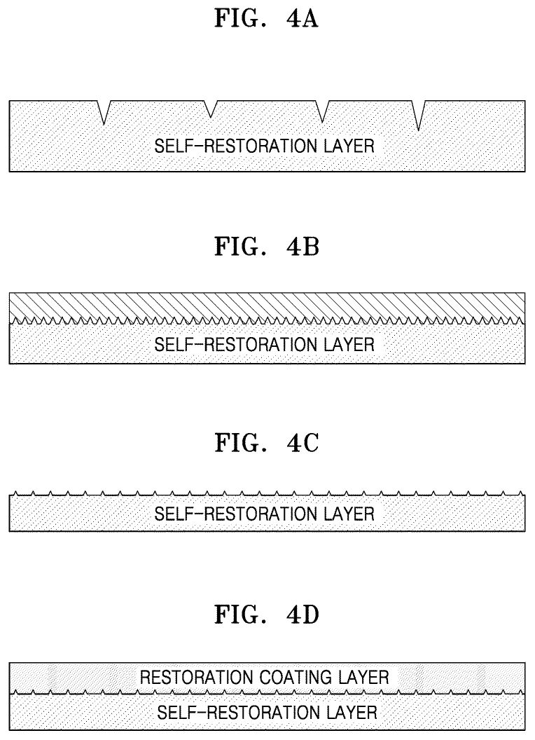

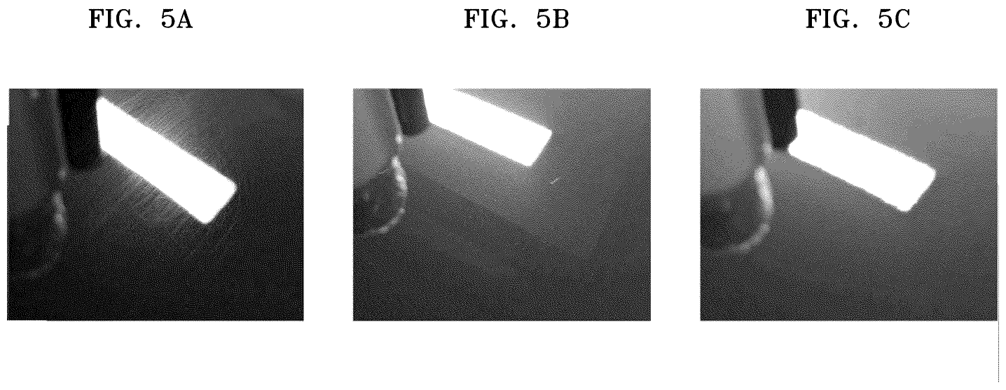

FIGS. 4A, 4B, 4C and 4D conceptually show a restoration solution for a vehicle protecting film using a compound composition according to one embodiment of the present invention. FIGS. 5A, 5B and 5C schematically show a state in which the method for restoring the vehicle protecting film according to one embodiment of the present invention is performed.

As shown FIGS. 4A and 5A, the restoration solution is configured to target a self-restoration layer having an upper side in which damages including water spots and scratches are generated.

The restoration solution basically uses the compound composition described below. As shown in FIG. 4A, when a damaging material including a scratch digs into a surface of the self-restoration layer, the damaged portion may be removed by applying the compound composition to the self-restoration layer and then polishing the upper side of the self-restoration layer using a pad as shown in FIG. 4B.

The surface of the self-restoration layer may be polished to a damaged depth due to the damage including scratches. Preferably, when the vehicle protecting film includes a self-restoration layer in which a damage is generated on an upper side of the vehicle protecting film, the damage may be removed by applying the compound composition to the self-restoration layer and then polishing an upper side of the self-restoration layer by a predetermined thickness using a pad.

According to one embodiment of the present invention, FIG. 4B corresponds to performing the first compound polishing step (S11).

In the first compound polishing step (S11), since the compound composition containing the first abrasive having a relatively large particle size is applied as described above, a fine surface damage due to abrasive particles may occur on the surface of the self-restoration layer after the first compound polishing step (S11), and accordingly, the non-glossy phenomenon may occur.

The restoration solution according to one embodiment of the present invention, after the first compound polishing step (S11) as shown in FIG. 4B, may polish the surface of the self-restoration layer by using a compound composition containing a first abrasive having a relatively small particle size compared to the first abrasive contained in the compound composition used in the first compound polishing step (S11), thereby removing the fine surface damage as shown in FIGS. 4C and 5C, so that the non-glossy phenomenon confirmed with the naked eye can be removed. Preferably, the first compound composition includes an abrasive having a larger particle size compared to the second compound composition.

In other words, according to one embodiment of the present invention, FIG. 4C corresponds to performing the second compound polishing step (S14). The restoration solution polishes the surface of the vehicle protecting film by using the compound composition, and even removes a damage generated during polishing, so that the vehicle protecting film can be restored.

According to one embodiment of the present invention, FIG. 4D corresponds to performing the coating solution step (S20).

Since the self-restoration layer of the vehicle protecting film may have a thickness thinner than the initial thickness after the first compound polishing step (S11) and the second compound polishing step (S14), an inner portion may be partially exposed to the outside. In this case, it is difficult to respond to an external impact since the self-restoration layer of the vehicle protecting film may have performance lowered compared to the initial stage as described above. Thus, as shown FIGS. 4D and 5C a restoration coating layer may be formed on the upper side of the polished vehicle protecting film.

In other words, the restoration solution according to one embodiment of the present invention forms a restoration coating layer on the upper side of the self-restoration layer of the vehicle protecting film having been thinner due to polishing, so that the performance of the vehicle protecting film even after the restoration solution can be implemented to be equivalent to or better than the initial performance.

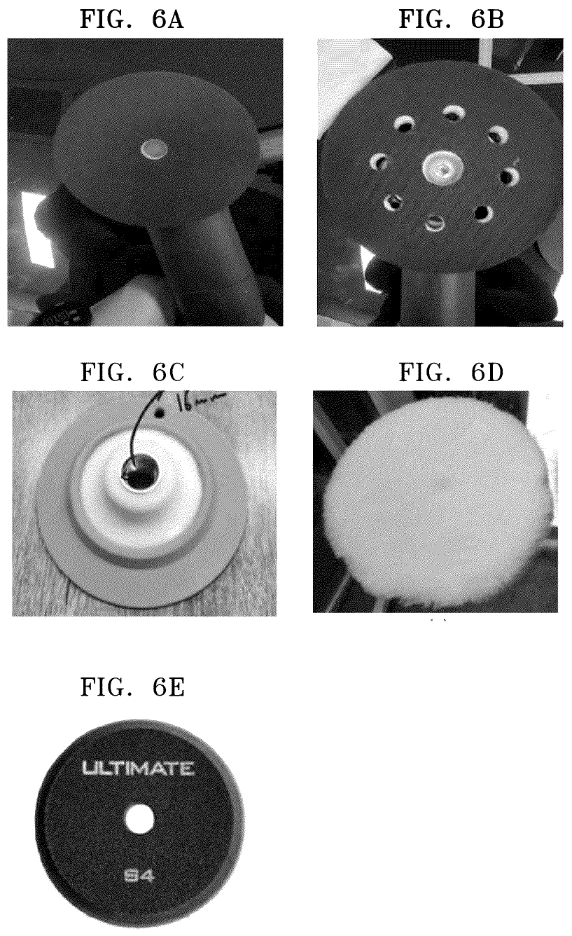

FIGS. 6A, 6B, 6C, 6D and 6E schematically show a first polishing pad and a second polishing pad according to one embodiment of the present invention.

Each of the first polishing pad and the second polishing pad is configured as a whole such that the pad is attached to the polisher.

The polisher includes a single-type polisher as shown in FIG. 6A. The single-type polisher is characterized to have cutting force and high heat generation, which are relatively high, so as to work quickly on a large area. In addition, the polisher includes a dual-type polisher as shown in FIG. 6B. The dual-type polisher is characterized to have cutting force and low heat generation, which are relatively low, so as to work slowly.

The pad includes a backup pad as shown in FIG. 6C, a dedicated wool pad as shown in FIG. 6D, and a dedicated foam pad as shown in FIG. 6E.

The backup pad may be preferably used only when being attached to the single-type polisher, and further include two types of screws for attaching the pad to the single-type polisher.

The dedicated wool pad may be preferably applied only to the first polishing pad. The dedicated wool pad refers to a wool pad with improved hair loss compared to the conventional wool pad, and has relatively excellent workability.

The dedicated foam pad may be preferably applied only to the second polishing pad. The dedicated foam pad has excellent durability and is easily controlled.

As in the above, the first polishing pad and the second polishing pad have different types of pads attached to the polisher, and accordingly, an operator is allowed to more efficiently perform each of the first compound polishing step (S11) and the second compound polishing step (S14).

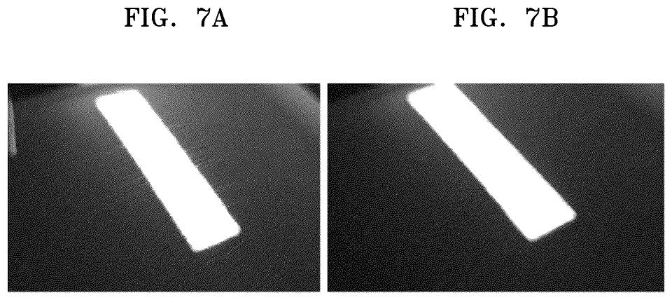

FIGS. 7A and 7B schematically show a state in which the gloss solution step (S10) is performed using a dedicated wool pad according to one embodiment of the present invention.

FIG. 7A is a photograph showing the surface of the vehicle protecting film after performing the second compound polishing step (S14) using the conventional wool pad. As shown in FIG. 7A, it can be seen that scratches are generated on the surface of the vehicle protecting film by the first compound polishing step (S11), and hairs of the wool pad are partially unhaired and attached to the surface of the vehicle protecting film.

FIG. 7B is a photograph showing the surface of the vehicle protecting film after performing the second compound polishing step (S14) using the dedicated wool pad according to one embodiment of the present invention. As shown in FIG. 7B, it can be seen that, when the dedicated wool pad is used, the surface of the vehicle protecting film can be polished so as to have excellent gloss without scratches compared to using the conventional wool pad.

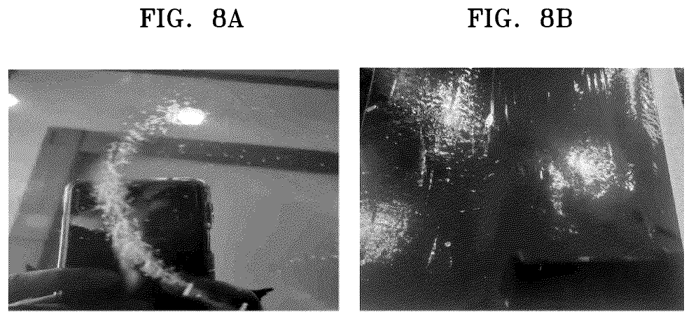

FIGS. 8A and 8B schematically show states in which the vehicle protecting film is polished using a conventional compound.

FIG. 8A is a picture of a surface of a vehicle protecting film polished using #3000 compound of 3M Company, FIG. 8B is a picture of a surface of a vehicle protecting film polished using #105 of McGuire Company.

As shown in FIG. 8A to FIG. 8B, it can be seen that, when the surface of the vehicle protecting film is polished using the conventional compounds, the surface of the vehicle protecting film is damaged, such as being locally lifted, pushed or burned. This is because the vehicle protecting film has a self-restoration layer that is vulnerable to heat. Although the compound is required to be prevented from being evaporated during polishing work to protect the self-restoration layer, the conventional compounds are evaporated too quickly during the polishing work, and accordingly, only the abrasive ingredients remain, thereby causing a damage to the self-restoration layer.

In general, heat generated during the polishing work may increase a surface temperature of the vehicle protecting film to 85° C. to 95° C.

In other words, in order to polish the surface of the vehicle protecting film using a compound to remove the damage, it is necessary to use a compound composition capable of protecting a self-restoration layer of a vehicle protecting film from heat generated during polishing work.

According to the present invention in order to solve the above-described problems in the related art, a lubricant having an evaporation point of 150° C. or higher is added to a compound composition.

More particularly, the present invention relates to a compound composition for restoring a vehicle protecting film, and includes an abrasive, a lubricant and a solvent as a whole, and the lubricant has a feature of having an evaporation point of 150° C. or higher. Due to the feature, the compound composition of the present invention may remain on the surface of the vehicle protecting film even during polishing work, so that the surface of the vehicle protecting film can be prevented from being damaged.

In other words, the present invention provides a compound composite for restoring a protecting film for a vehicle, in which a lubricant having an evaporation point of 150° C. or higher is added to evaporate the compound composition at an appropriate rate during polishing work, so that the vehicle protecting film for a vehicle can be restored without a damage.

Hereinafter, the compound composition and the restoration coating composition used in the restoration solution according to one embodiment of the present invention will be described in detail.

### Compound Composition

A compound composite for restoring a protecting film for a vehicle according to one embodiment of the present invention may include: an abrasive containing metal oxide powder; a lubricant having an evaporation point of 150° C. or higher; and a solvent containing water.

In the above configuration, the compound composition may include a first compound composition applied in the first compound polishing step (S11), and a second compound composition applied in the second compound polishing step (S14).

The abrasive corresponds to a material capable of polishing a surface of a vehicle protecting film or a surface of a self-restoration layer of the vehicle protecting film.

When the compound composition is applied to the surface of the vehicle protecting film, metal oxide powder contained in the abrasive may come into contact with the surface of the vehicle protecting film. In this state, when the user buffs while spreading the compound composition by using a pad described later, the surface of the vehicle protecting film may be directly polished.

The metal oxide powder according to one embodiment of the present invention may include any one of aluminum oxide and silicon carbide.

It is common for abrasives to name a particle size by using the ANSI (Grit) standard, and grits are attached to the ANSI numbers. The grit is a unit expressing how many particles (metal oxide powder) are contained per inch, and the particle size contained in the abrasive is smaller when the number is higher.

the abrasive according to one embodiment of the present invention may include, based on ANSI (Grit) standards: a first abrasive having a particle size of 1400 grits to 2800 grits or a particle size of 4000 grits to 6000 grits; and a second abrasive having a particle size of 2800 grits to 3350 grits. The first abrasive may preferably have a particle size of 1400 grits to 2800 grits, or have a particle size of 4000 grits to 6000 grits, depending on a step in which the compound composition is applied.

For example, the first abrasive may have a particle size of 1400 grits to 2800 grits (more preferably have a particle size of 2000 grits) when the compound composition is applied in the first compound polishing step (S11), and have a particle size of 4000 grits to 6000 grits (more preferably have a particle size of 5000 grits) when the compound composition is applied in the second compound polishing step (S14).

In other words, the compound composition used in the first compound polishing step (S11) has a first abrasive having a larger particle size compared to the compound composition used in the second compound polishing step (S14). The compound composition used in the first compound polishing step (S11) corresponds to the first compound composition, and the compound composition used in the second compound polishing step (S14) corresponds to the second compound composition.

The compound composition contains an abrasive having a specific particle size as above, so as to evenly polish the surface of the vehicle protecting film, so that the completion of the polishing work can be improved.

Preferably, the compound composition according to one embodiment of the present invention may include 10 wt % to 20 wt % of an abrasive based on a total weight.

The composition range of the abrasive corresponds to a range capable of polishing all damage such as scratches generated on the surface of the vehicle protecting film. In other words, the abrasive is composed of the above composition, so that a solution capable of using the compound composition to polish and manage the surface of the vehicle protecting film can be provided.

Preferably, the compound composition may include 5 wt % to 15 wt % of a first abrasive, and 0.1 wt % to 10 wt % of a second abrasive, based on a total weight.

The above composition range of the first abrasive and the second abrasive corresponds to a range for removing all damage that is visibly checked and preventing a cause of non-glossy phenomenon. In other words, the abrasive includes the first abrasive and the second abrasive composed of the above composition, so that all damage generated on the surface of the vehicle protecting film is removed using the compound composition, and excellent installation completion can be implemented in which the gloss of the vehicle protecting film is prevented from being damaged.

The lubricant corresponds to a material that controls the liquidus viscosity and the volatilization rate of the compound composition.

When the volatilization rate of the compound composition is improperly controlled, only abrasive ingredients may remain during polishing work. In this case, since the frictional force between the abrasive and the surface of the vehicle protecting film may be increased, the heat generation rate on the surface of the vehicle protecting film may be further increased. The surface temperature of the vehicle protecting film during the polishing work is 85 to 95° C., which is relatively lower than a melting point of TPU that is a major material of the vehicle protecting film. However, attention is required since the surface of the vehicle protecting film may be damaged by pressure and heat generated during the polishing work even when the temperature lasts only a few seconds.

In other words, according to the present invention, a lubricant is added to the compound composition, in which the lubricant has an evaporation point of 150° C. or higher, so as to prevent the compound composition from rapidly being evaporated and only the abrasive ingredients from remaining during polishing work. Preferably, the lubricant having an evaporation point of 150° C. or higher may be added to the compound composition, and accordingly, the compound composition may remain on the surface of the vehicle protecting film even during polishing work, so that the surface of the vehicle protecting film can be prevented from being damaged.

The lubricant according to one embodiment of the present invention may include: a first lubricant having a predetermined evaporation point; and a second lubricant having an evaporation point equal to or higher than the evaporation point of the first lubricant.

Preferably, the first lubricant may have an evaporation point of 150° C. or higher, and the second lubricant may have an evaporation point of 150° C. to 400° C. More preferably, the first lubricant may have an evaporation point of 150° C., and the second lubricant may have an evaporation point of 250° C.

In other words, the compound composition of the present invention includes a combination of a first lubricant and a second lubricant, and particularly contains a second lubricant having an evaporation point of 250° C., so that the vehicle protecting film can be effectively restored. Preferably, a combination of the first lubricant having an oil evaporation point of 150° C. and the second lubricant having an oil evaporation point of 250° C. may be added to the compound composition, so that the vehicle protecting film can be more effectively restored.

Preferably, the compound composition according to one embodiment of the present invention includes 15 wt % to 25 wt % of a lubricant based on a total weight. Preferably, the compound composition may include 15 wt % to 25 wt % of a first lubricant, and 0.5 wt % to 5 wt % of a second lubricant, based on a total weight.

The above composition range of the lubricant corresponds to a range for controlling the liquidus viscosity and the volatilization rate of the compound composition to a predetermined range. In other words, the lubricant includes the first lubricant and the second lubricant configured to have the above composition, so as to prevent the phenomenon, in which only the abrasive of the compound composition remains while polishing the surface of the vehicle protecting film, so that excellent resilience can be realized.

The solvent, similarly to the lubricant, corresponds to a material for controlling the liquidus viscosity and the volatilization rate of the compound composition.

According to one embodiment of the present invention, since the solvent includes water, and the surface temperature of the vehicle protecting film during polishing work is 85° C. to 95° C., which is below the boiling point of water as described above, the evaporation rate of the compound composition can be controlled.

In the above manner, water is used as a solvent for the compound composition in considering that the surface temperature of the vehicle protecting film during polishing work is about 90° C., so that the compound composition can be evaporated at an appropriate rate during the polishing work.

Preferably, the compound composition according to one embodiment of the present invention may include 45 wt % to 55 wt % of a solvent based on a total weight.

The above composition range of the solvent corresponds to a range for controlling the liquidus viscosity and the volatilization rate of the compound composition to a predetermined range. In other words, the solvent is composed of the above composition, to prevent the phenomenon, in which only the abrasive of the compound composition remains while polishing the surface of the vehicle protecting film, so that excellent resilience can be realized.

The compound composition may further include an additive.

Preferably, the additive may include: a first moisturizer containing glycerin; a solvent containing DPNB; a lubricating solvent containing castor oil; a thickener containing DR-; a second moisturizer; an emulsifying preservative containing morpholine; and an antiseptic containing SB-20.

More preferably, the additive may include: 3.5 wt % to 5.5 wt % of a first moisturizer; 1.5 wt % to 3.5 wt % of a solvent; 0.5 wt % to 2.5 wt % of a lubricating solvent; 0.5 wt % to 2.5 wt % of a thickener; 0.1 wt % to 1 wt % of a second moisturizer; 0.1 wt % to 0.3 wt % of an emulsifying preservative; and 0.1 wt % to 0.3 wt % of an antiseptic.

Hereinafter, tests were conducted on whether the surface of the vehicle protecting film was polished without a damage by using the compound composition according to one embodiment of the present invention. The results will be described in detail.

### Test #1 on Polishing Vehicle Protecting Film by Using Compound Composition

This test is designed to confirm whether the compound composition polishes the surface of the vehicle protecting film without a damage, while the compound composition according to the embodiments of the present invention contains a second lubricant having an oil evaporation point of 150° C.

Specifically, in this test, four compound compositions according to one embodiment of the present invention, which differ only in the content of the second lubricant having an oil evaporation point of 150° C., are prepared. After each of the four compound compositions is applied to a surface of the vehicle protecting film, heat is repeatedly applied at 90° C. for 2 hours in considering that the surface temperature of the vehicle protecting film rises to 85° C. to 95° C. during polishing work. It is confirmed with naked eyes whether oil ingredients of the compound composition remain after the heat is applied.

The four compound compositions according to the embodiments of the present invention correspond to the compound compositions having following combinations, respectively.

### Compound Composition Example 1

A compound composition including 10 wt % of a first abrasive, 4.5 wt % of a second abrasive, 20 wt % of a first lubricant, 0.5 wt % of a second lubricant, 51.97 wt % of a solvent, and 11.03 wt % of an additive, based on a total weight.

### Compound Composition Example 2

A compound composition including 10 wt % of a first abrasive, 4.5 wt % of a second abrasive, 20 wt % of a first lubricant, 1 wt % of a second lubricant, 51.97 wt % of a solvent, and 11.03 wt % of an additive, based on a total weight.

### Compound Composition Example 3

A compound composition including 10 wt % of a first abrasive, 4.5 wt % of a second abrasive, 20 wt % of a first lubricant, 1.5 wt % of a second lubricant, 51.97 wt % of a solvent, and 11.03 wt % of an additive, based on a total weight.

### Compound Composition Example 4

A compound composition including 10 wt % of a first abrasive, 4.5 wt % of a second abrasive, 20 wt % of a first lubricant, 2 wt % of a second lubricant, 51.97 wt % of a solvent, and 11.03 wt % of an additive, based on a total weight.

The first lubricants of the compound composition Example 1 to compound composition Example 4 correspond to lubricants having an oil evaporation point of 150° C., and the second lubricants of the compound composition Example 1 to compound composition Example 4 correspond to lubricants having an oil evaporation point of 150° C. like the first lubricants but it is preferable to be different from products of manufacturers of the first lubricants.

In addition, it is preferable that all of the additives of the compound composition Example 1 to compound composition Example 4 are composed of ingredients and combinations corresponding to each other.

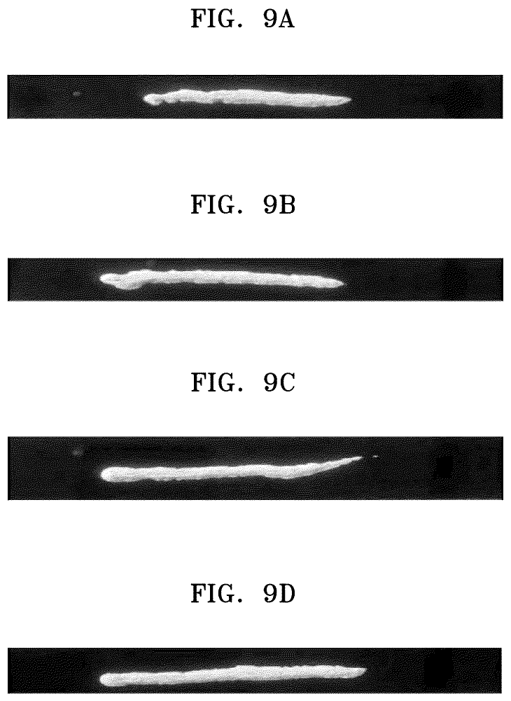

FIGS. 9A, 9B, 9C and 9D schematically show results on test #1 of polishing the compound composition according to one embodiment of the present invention.

FIG. 9A is a photograph of a vehicle protecting film after applying Example 1 and applying heat to the surface. As shown in FIG. 9A, it can be seen that Example 1 indicates that no oil ingredient remains after the heat is applied.

FIG. 9B is a photograph of a vehicle protecting film after applying Example 2 and applying heat to the surface. As shown in FIG. 9B, it can be seen that Example 2 indicates that no oil ingredient remains after the heat is applied.

FIG. 9C is a photograph of a vehicle protecting film after applying Example 3 and applying heat to the surface. As shown in FIG. 9C, it can be seen that Example 3 indicates that no oil ingredient remains after the heat is applied.

FIG. 9D is a photograph of a vehicle protecting film after applying Example 4 and applying heat to the surface. As shown in FIG. 9D, it can be seen that Example 4 indicates that no oil ingredient remains after the heat is applied.

The absence of oil ingredients after applying heat signifies that the compound composition is quickly evaporated during polishing work, and accordingly the surface of the vehicle protecting film may be damaged.

In other words, it is confirmed through Test #1 that, when the surface of the vehicle protecting film is polished by using the compound composition in which the combination of the first lubricant having an oil evaporation point of 150° C. and the second lubricant having an oil evaporation point of 150° C. is added, the compound composition is quickly evaporated during polishing work, and accordingly the self-restoration layer of the vehicle protecting film may be damaged.

### Test #2 on Polishing Vehicle Protecting Film by Using Compound Composition

This test is designed to confirm whether the compound composition polishes the surface of the vehicle protecting film without a damage, while the compound composition according to the embodiments of the present invention contains a second lubricant having an oil evaporation point of 200° C.

Specifically, in this test, four compound compositions according to one embodiment of the present invention, which differ only in the content of the second lubricant having an oil evaporation point of 200° C., are prepared. After each of the four compound compositions is applied to a surface of the vehicle protecting film, heat is repeatedly applied at 90° C. for 2 hours in considering that the surface temperature of the vehicle protecting film rises to 85° C. to 95° C. during polishing work. It is confirmed with naked eyes whether oil ingredients of the compound composition remain after the heat is applied.

The four compound compositions according to the embodiments of the present invention correspond to the compound compositions having following combinations, respectively.

### Compound Composition Example 5

A compound composition including 10 wt % of a first abrasive, 4.5 wt % of a second abrasive, 20 wt % of a first lubricant, 0.5 wt % of a second lubricant, 51.97 wt % of a solvent, and 11.03 wt % of an additive, based on a total weight.

### Compound Composition Example 6

A compound composition including 10 wt % of a first abrasive, 4.5 wt % of a second abrasive, 20 wt % of a first lubricant, 1 wt % of a second lubricant, 51.97 wt % of a solvent, and 11.03 wt % of an additive, based on a total weight.

### Compound Composition Example 7

A compound composition including 10 wt % of a first abrasive, 4.5 wt % of a second abrasive, 20 wt % of a first lubricant, 1.5 wt % of a second lubricant, 51.97 wt % of a solvent, and 11.03 wt % of an additive, based on a total weight.

### Compound Composition Example 8

A compound composition including 10 wt % of a first abrasive, 4.5 wt % of a second abrasive, 20 wt % of a first lubricant, 2 wt % of a second lubricant, 51.97 wt % of a solvent, and 11.03 wt % of an additive, based on a total weight.

The first lubricants of the compound composition Example 5 to compound composition Example 8 correspond to lubricants having an oil evaporation point of 150° C., and the second lubricants of the compound composition Example 5 to compound composition Example 8 correspond to lubricants having an oil evaporation point of 200° C.

In addition, it is preferable that all of the additives of the compound composition Example 5 to compound composition Example 8 are composed of ingredients and combinations corresponding to each other.

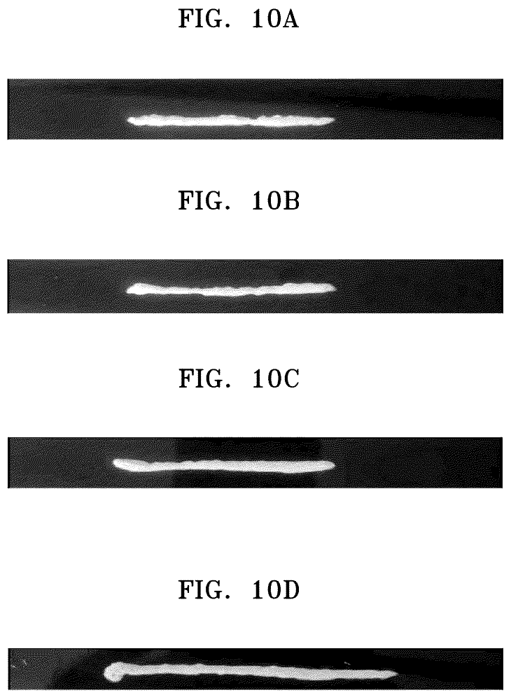

FIGS. 10A, 10B, 10C and 10D schematically show results on test #2 of polishing the compound composition according to one embodiment of the present invention.

FIG. 10A is a photograph of a vehicle protecting film after applying Example 5 and applying heat to the surface. As shown in FIG. 10A, it can be seen that Example 5 indicates that no oil ingredient remains after the heat is applied.

FIG. 10B is a photograph of a vehicle protecting film after applying Example 6 and applying heat to the surface. As shown in FIG. 10B, it can be seen that Example 6 indicates that no oil ingredient remains after the heat is applied. FIG. 10C is a photograph of a vehicle protecting film after applying Example 7 and applying heat to the surface. As shown in FIG. 10C, it can be seen that Example 7 indicates that no oil ingredient remains after the heat is applied.

FIG. 10D is a photograph of a vehicle protecting film after applying Example 8 and applying heat to the surface. As shown in FIG. 10D, it can be seen that Example 8 indicates that a relatively weak oil trace remains after the heat is applied.

As described above, the absence of oil ingredients after applying heat signifies that the compound composition is quickly evaporated during polishing work, and accordingly the surface of the vehicle protecting film may be damaged.

The presence of oil ingredients after applying heat signifies that the compound composition is not evaporated quickly but evaporated at an appropriate rate during the polishing work, and this signifies that the self-restoration layer of the vehicle protecting film is restored without being damaged by the polishing work.

Considering this, it is confirmed through Test #2 that, when the compound composition obtained by adding the combination of the first lubricant having an oil evaporation point of 150° C. and the second lubricant having an oil evaporation point of 200° C. is used according to one embodiment of the present invention, and when less than 2 wt % of the second lubricant is contained, the compound composition is quickly evaporated during polishing work, and accordingly the self-restoration layer of the vehicle protecting film may be damaged. However, when 2 wt % or higher of the second lubricant is contained, the surface of the vehicle protecting film may be polished without a damage.

### Test #3 on Polishing Vehicle Protecting Film by Using Compound Composition

This test is designed to confirm whether the compound composition polishes the surface of the vehicle protecting film without a damage, while the compound composition according to the embodiments of the present invention contains a second lubricant having an oil evaporation point of 250° C.

Specifically, in this test, four compound compositions according to one embodiment of the present invention, which differ only in the content of the second lubricant having an oil evaporation point of 250° C., are prepared. After each of the four compound compositions is applied to a surface of the vehicle protecting film, heat is repeatedly applied at 90° C. for 2 hours in considering that the surface temperature of the vehicle protecting film rises to 85° C. to 95° C. during polishing work. It is confirmed with naked eyes whether oil ingredients of the compound composition remain after the heat is applied.

The four compound compositions according to the embodiments of the present invention correspond to the compound compositions having following combinations, respectively.

### Compound Composition Example 9

A compound composition including 10 wt % of a first abrasive, 4.5 wt % of a second abrasive, 20 wt % of a first lubricant, 0.5 wt % of a second lubricant, 51.97 wt % of a solvent, and 11.03 wt % of an additive, based on a total weight.

### Compound Composition Example 10

A compound composition including 10 wt % of a first abrasive, 4.5 wt % of a second abrasive, 20 wt % of a first lubricant, 1 wt % of a second lubricant, 51.97 wt % of a solvent, and 11.03 wt % of an additive, based on a total weight.

### Compound Composition Example 11

A compound composition including 10 wt % of a first abrasive, 4.5 wt % of a second abrasive, 20 wt % of a first lubricant, 1.5 wt % of a second lubricant, 51.97 wt % of a solvent, and 11.03 wt % of an additive, based on a total weight.

### Compound Composition Example 12

A compound composition including 10 wt % of a first abrasive, 4.5 wt % of a second abrasive, 20 wt % of a first lubricant, 2 wt % of a second lubricant, 51.97 wt % of a solvent, and 11.03 wt % of an additive, based on a total weight.

The first lubricants of the compound composition Example 9 to compound composition Example 12 correspond to lubricants having an oil evaporation point of 150° C., and the second lubricants of the compound composition Example 9 to compound composition Example 12 correspond to lubricants having an oil evaporation point of 250° C.

In addition, it is preferable that all of the additives of the compound composition Example 9 to compound composition Example 12 are composed of ingredients and combinations corresponding to each other.

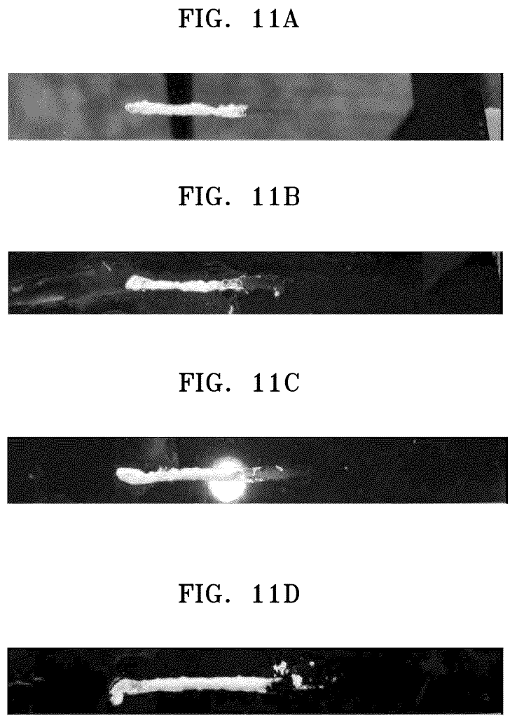

FIGS. 11A, 11B, 11C and 11D schematically show results on test #3 of polishing the compound composition according to one embodiment of the present invention.

FIG. 11A is a photograph of a vehicle protecting film after applying Example 9 and applying heat to the surface. As shown in FIG. 11A, it can be seen that Example 9 indicates that no oil ingredient remains after the heat is applied.

FIG. 11B is a photograph of a vehicle protecting film after applying Example 10 and applying heat to the surface. As shown in FIG. 11B, it can be seen that Example 10 indicates that a relatively weak oil trace remains after the heat is applied.

FIG. 11C is a photograph of a vehicle protecting film after applying Example 11 and applying heat to the surface. As shown in FIG. 11C, it can be seen that Example 11 indicates that oil residues remain after the heat is applied.

FIG. 11D is a photograph of a vehicle protecting film after applying Example 12 and applying heat to the surface. As shown in FIG. 11D, it can be seen that Example 12 indicates that oil residues remain after the heat is applied.

As described above, the absence of oil ingredients after applying heat signifies that the compound composition is quickly evaporated during polishing work, and accordingly the surface of the vehicle protecting film may be damaged.

Meanwhile, the presence of oil ingredients after applying heat signifies that the compound composition is not evaporated quickly but evaporated at an appropriate rate during the polishing work, and this signifies that the self-restoration layer of the vehicle protecting film is restored without being damaged by the polishing work.

Considering this, it is confirmed through Test #3 that, when the compound composition obtained by adding the combination of the first lubricant having an oil evaporation point of 150° C. and the second lubricant having an oil evaporation point of 250° C. is used according to an embodiment of the present invention, and when 0.5 wt % of the second lubricant is contained, the compound composition is quickly evaporated during polishing work, and accordingly the self-restoration layer of the vehicle protecting film may be damaged. However, when more than 0.5 wt % of the second lubricant is contained, the surface of the vehicle protecting film may be polished without a damage.

More particularly, it can be determined that Examples 11 and 12, in which oil residues are relatively clearly confirmed compared to the above-described Test #2, can more effectively prevent the surface of the vehicle protecting film from being damaged during the polishing work.

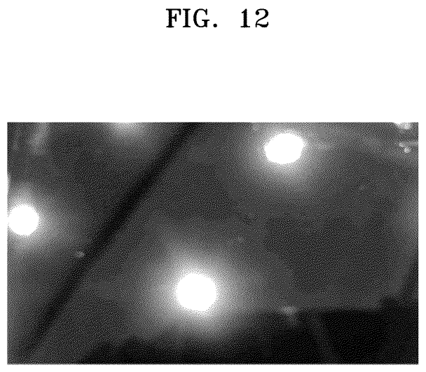

FIG. 12 schematically shows a state in which the vehicle protecting film is restored using the compound composition according to one embodiment of the present invention.

As confirmed in the above-described FIGS. 9 to 11, the compound composition according to one embodiment of the present invention may be used stably even when being left in heat generated for a long time during the polishing work, so that the vehicle protecting film can be managed, such as polishing, without a damage on the surface thereof.

In other words, when the compound composition is used, the damage to the vehicle protecting film can be removed without damaging the surface of the vehicle protecting film. More particularly, it can be confirmed that the non-glossy phenomenon due to polishing work does not occur on the surface of the vehicle protecting film as shown in FIG. 12, and the vehicle protecting film can be restored to have a gloss similar to that at the time of initially installing the vehicle protecting film.

The compound composition may preferably include a combination of a first lubricant having an oil evaporation point of 150° C. and a second lubricant having an oil evaporation point of 150° C. to 250° C. It is more preferable that the second lubricant has an oil evaporation point of 250° C. or higher.

### Restoration Coating Composition

The restoration coating composition according to one embodiment of the present invention may include: a polar solvent including any one of acetone, isopropyl alcohol (IPA), methyl isobutyl ketone (MIBK), and ethyl acetate (EA); a non-metallic material including any one of SiO₂ and polysilazane; an additive including a first silicone, a second silicone, and a solvent; and a non-polar solvent.

The polar solvent corresponds to a material for improving adhesion between the restoration coating layer and the self-restoration layer of the vehicle protecting film.

As described above, in the related art, since the inside of the self-restoration layer is exposed to the outside due to the polishing work, and the slip additive added to the coating layer interferes with the coating layer from adhering to the surface of the self-restoration layer, quality of the coating layer is significantly deteriorated. The slip additive corresponds to an additive for making the surface of the coating layer slippery to increase a scratch resistance.

According to the present invention in order to solve the above problem, the polar solvent is added to the restoration coating composition. When the polar solvent is added to the restoration coating composition, the phenomenon of deteriorating the adhesion between the restoration coating layer and the self-restoration layer due to the slip additive is restrained, and the adhesion between the self-restoration layer and the restoring coating layer is improved while the surface of the self-restoration layer is instantly melted, so that the restoration coating layer having excellent quality can be formed.

In other words, the polar solvent is added to the restoration coating composition in the above manner, thereby improving the adhesion between the restoration coating composition and the vehicle protecting film when the restoration coating layer is formed on the surface of the self-restoration layer of the vehicle protecting film, so that coating completion can be improved.

Preferably, the restoration coating composition according to one embodiment of the present invention may include 10 wt % to 20 wt % of a polar solvent based on a total weight, and more preferably, may include 15 wt % of a polar solvent.

The composition range of the polar solvent corresponds to a range capable of lowering the surface hardness of the self-restoration layer, and the surface hardness may be preferably maintained until the restoration coating layer is formed. In other words, when the polar solvent is composed of the above combination, the restoration coating composition is used, so that the high-quality restoration coating layer can be implemented on the upper side of the self-restoration layer of the vehicle protecting film.

Meanwhile, the polar solvent may include at least one of acetone, isopropyl alcohol (IPA), methyl isobutyl ketone (MIBK), and ethyl acetate (EA), and preferably, may include acetone.

Results on quality tests of the restoration coating layer according to types of the polar solvent will be described later.

The non-metallic material serving as a main ingredient of the restoration coating layer, and refers to a material for allowing the restoration coating layer to be formed by a thickness of the self-restoration layer of the vehicle protecting film polished through the gloss solution step (S10).

As described above, since the related art uses a coating composition containing about 10 wt % of a non-metallic material, a coating layer cannot be formed as much as a polished thickness of the vehicle protecting film, and accordingly, the overall thickness of the vehicle protecting film becomes thinner after polishing work.

According to the present invention in order to solve the above problem, the non-metallic material is added to the restoration coating composition. Preferably, the restoration coating composition according to one embodiment of the present invention may include 50 wt % to 70 wt % of a non-metallic material based on a total weight, and more preferably, may include 60 wt % of a non-metallic material.

The composition range of the non-metallic material corresponds to a range for allowing the restoration coating layer to be formed to have a thickness corresponding to the thickness of the self-restoration layer of the vehicle protecting film polished through the gloss solution step (S10), in which the thickness corresponds to the depth of the damage generated on the surface of the self-restoration layer. In one embodiment of the invention, the restoration coating layer may have a thickness of 1 micrometer to 5 micrometers, and preferably, may have a thickness of micrometers.

In other words, a relatively high content of the non-metallic material is added to the restoration coating composition in the above manner, so that the restoration coating layer having a thickness equal to a thickness of the vehicle protecting film polished through polishing work can be formed.

The additive corresponds to a material for controlling adhesion, durability, slipperiness, and color of the restoration coating layer.

The restoration coating composition according to one embodiment of the present invention may include 10 wt % to 50 wt % of an additive based on a total weight. The composition range of the additive corresponds to a range capable of improving adhesion between the restoration coating layer and the self-restoration layer, and improving durability and slipperiness of the restoration coating layer.

In one embodiment of the invention, the additive may include: 5 wt % to 15 wt % of a first silicone additive; and 1 wt % to 3 wt % of a second silicone additive. The first silicone additive corresponds to a material for controlling adhesion and durability of the restoration coating layer, and the second silicone additive corresponds to a material for controlling slipperiness and color of the restoration coating layer.

The second silicone additive may be preferably added in a relatively small amount compared to the first silicone additive. This is because the content of the non-metallic material in the total ratio is decreased when the content of the slip agent is increased, and accordingly, it may be difficult to form the restoration coating layer as much as being polished, which is the purpose of the restoration coating composition, and this is because it may be difficult to use chemicals such ceramic coating agents and maintenance agents used in vehicle protecting films when water repellency is imparted by increasing the slipperiness of the restoration coating composition. Preferably, the second silicone additive may be added in an amount by wt % such that a water contact angle of the restoration coating composition is 85 degrees to 95 degrees, more preferably 90 degrees.

In addition, the above-described composition range of the second silicone additive may preferably correspond to a range capable of instantly melting the surface of the self-restoration layer to improve the adhesion between the restoring coating layer and the self-restoration layer when the restoration coating layer is formed on the surface of the self-restoration layer.

Hereinafter, tests are performed on the restoration coating layer formed using the restoration coating composition according to one embodiment of the present invention, and the results will be described in detail.

### Coating Test on Restoration Coating Composition

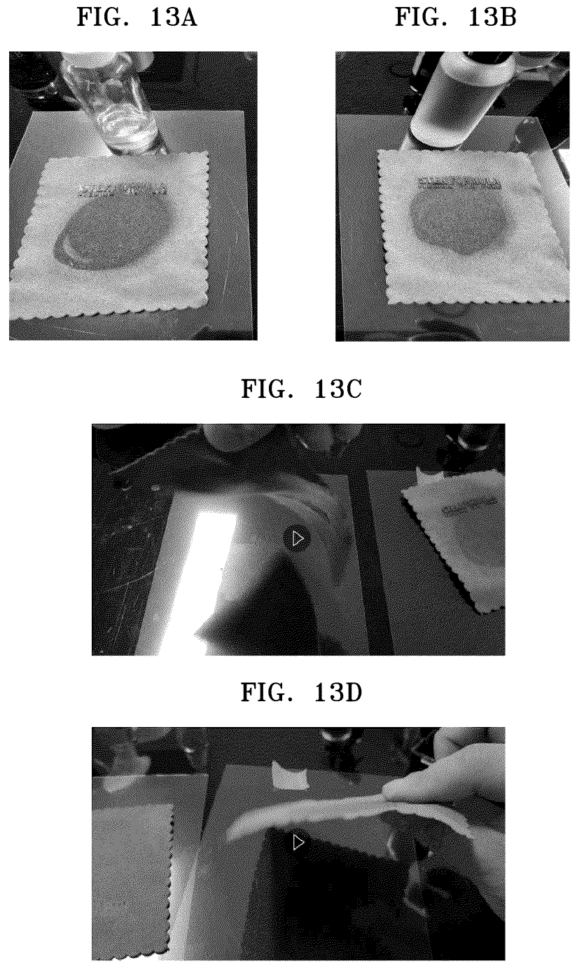

FIGS. 13A, 13B, 13C and 13D schematically show details of a coating test of the restoration coating composition according to one embodiment of the present invention.

This test is designed to check whether the restoration coating composition according to one embodiment of the present invention forms a restoration coating layer having superior performance compared to the related art.

Specifically, in the tests, as shown in FIGS. 13A and 13B, each of restoration coating compositions of the conventional coating compositions and the present invention is applied to a microfiber surface to form a coating layer, and then the microfiber surface is shaken to confirm the hardness of the coating layer.

The composition may be preferable to form a coating layer having high hardness, so as to restore the thickness of the self-restoration layer of the vehicle protecting film having been thin during polishing work. In this case, it can be determined that the coating layer has excellent performance.

FIG. 13C shows the test result using the conventional coating composition. As shown in FIG. 13C, it can be seen that the conventional coating composition forms a coating layer having relatively low hardness, and the coating layer moves according to movements of the microfiber surface when the microfiber surface formed with the coating layer is shaken.

FIG. 13D shows the test result using the restoration coating composition according to one embodiment of the present invention. As shown in FIG. 13D, it can be seen that the restoration coating composition forms a restoration coating layer having relatively high hardness, and the restoration coating layer does not move according to movements of the microfiber surface, but rather has hardness sufficient to fix the movements of the microfiber surface even when the microfiber surface formed with the restoration coating layer is shaken.

As in the above, it can be seen that the restoration coating composition according to one embodiment of the present invention may form a restoration coating layer suitable for restoring the thickness of the polished self-restoration layer, and protecting the damaged surface from being damaged or having deteriorated performance.

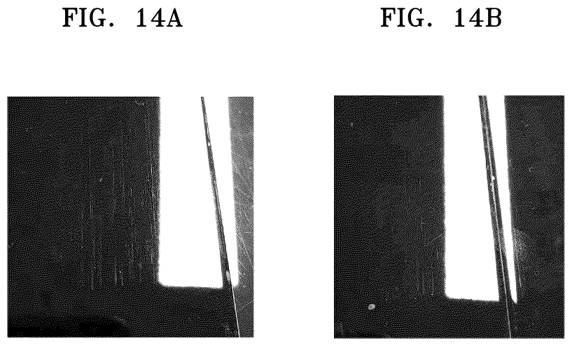

FIGS. 14A and 14B schematically show a state in which the vehicle protecting film formed with a restoration coating layer according to one embodiment of the present invention is restored.

FIG. 14A shows the surface of the vehicle protecting film including a damaged self-restoration layer on the upper side. FIG. 14B shows the surface of the vehicle protecting film one week after the restoration coating layer according to one embodiment of the present invention is formed.

Accordingly, it can be confirmed that the restoration coating layer has excellent abrasion resistance compared to the uncoated vehicle protecting film, and has no abnormalities in self-restoring performance.

### Quality Test on Restoration Coating Layer

This test is designed to check changes in quality of the restoration coating layer according to the embodiments of the present invention depending on types of polar solvent.

Specifically, in this test, four restoration coating compositions according to one embodiment of the present invention are prepared to have only the different types of polar solvent. Each of the four restoration coating compositions is applied to the surface of the vehicle protecting film to have a thickness observed with the naked eye, and then cured to form a restoration coating layer. Each restoration coating layer is polished to confirm, with the naked eye, the extent to which the restoration coating layer is peeled off.

The four restoration coating compositions according to the embodiments of the present invention correspond to the restoration coating compositions having following combinations, respectively.

### Restoration Coating Composition Example 1

A restoration coating composition including 15 wt % of IPA; 60 wt % of an inorganic polysilazane; 10 wt % of a first silicone additive; 2 wt % of a second silicone additive; and 13 wt % of a non-polar solvent, based on a total weight.

### Restoration Coating Composition Example 2

A restoration coating composition including 15 wt % of MIBK; 60 wt % of an inorganic polysilazane; 10 wt % of a first silicone additive; 2 wt % of a second silicone additive; and 13 wt % of a non-polar solvent, based on a total weight.

### Restoration Coating Composition Example 3

A restoration coating composition including 15 wt % of acetone; 60 wt % of an inorganic polysilazane; 10 wt % of a first silicone additive; 2 wt % of a second silicone additive; and 13 wt % of a non-polar solvent, based on a total weight.

### Restoration Coating Composition Example 4

A restoration coating composition including 15 wt % of EA; 60 wt % of an inorganic polysilazane; 10 wt % of a first silicone additive; 2 wt % of a second silicone additive; and 13 wt % of a non-polar solvent, based on a total weight.

it may be preferable that all of the restoration coating composition Example 1 to restoration coating composition Example 4 are composed of ingredients and combinations corresponding to each other, except for ingredients corresponding to the polar solvent.

The test results are shown in Table 1 as below.

TABLE 1

| Type of | Degree of peeling | Whether |
|---|---|---|
| Polar | (100% − Entirely | self-restoration |
| solvent | peeled off) | layer is damaged |
| IPA | 50% | No |
| MIBK | 10% | Yes |
| Acetone | 10% | No |
| EA | 30% | Yes |

As shown in Table 1, it can be seen that restoration coating composition Example 2 and restoration coating composition Example 3 are peeled off relatively the least, and restoration coating composition Example 4 and restoration coating composition Example 1 are sequentially highly peeled off.

Regarding whether the self-restoration layer is damaged, it can be confirmed that restoration coating composition Example 2 and Restoration coating composition Example 4 have no damage, but the restoration coating composition Example 1 and the restoration coating composition Example 3 are damaged.

Based on the above results, the restoration coating composition of the present invention can form the restoration coating layer capable of minimizing the surface damage of the self-restoration layer while maximizing adhesion with the self-restoration layer, and it may be preferable to include acetone as a polar solvent.

One embodiment of the present invention provides a restoration solution configured such that the surface is polished using a compound composition containing a lubricant having an evaporation point of 150° C. or higher and then the surface is coated using a restoration coating composition containing a polar solvent, so that the damaged vehicle protecting film can be restored without replacing the vehicle protecting film.

According to one embodiment of the present invention, the non-glossy phenomenon confirmed with the naked eye is removed by primarily removing a damage such as a scratch formed on a surface by polishing and then secondarily removing scratches generated due to polishing work by additionally polishing, so that a gloss of the vehicle protecting film can be restored only by the polishing work.

According to one embodiment of the present invention, a restoration coating layer is formed on the self-restoration layer of the vehicle protecting film after the polishing work, thereby preventing the self-restoration layer of the vehicle protecting film from being exposed to the outside due to the polishing work and lowering performance, so that restoration completion can be improved.

According to one embodiment of the present invention, the restoration coating layer is formed on the surface of the vehicle protecting film damaged by the thickness polished through the gloss solution step, so that the phenomenon, in which the thickness of the vehicle protecting film is reduced due to the polishing work and the protective performance of the film is lowered, can be prevented.

According to one embodiment of the present invention, the polar solvent is added to the restoration coating composition, thereby improving the adhesion between the restoration coating composition and the vehicle protecting film when the restoration coating layer is formed on the surface of the self-restoration layer of the vehicle protecting film, so that coating completion can be improved.

According to one embodiment of the present invention, the relatively high content of the non-metallic material is added to the restoration coating composition, so that the restoration coating layer having a thickness equal to a thickness of the vehicle protecting film polished through polishing work can be formed.

One embodiment of the present invention may provide a compound composite for restoring a vehicle protecting film, when a lubricant having an evaporation point of 150° C. or higher is added, to evaporate the compound composition at an appropriate rate during polishing work, so that the vehicle protecting film for a vehicle can be restored without a damage.

According to one embodiment of the present invention, water is used as a solvent for the compound composition in considering that the surface temperature of the vehicle protecting film during polishing work is about 90° C., so that the compound composition can be evaporated at an appropriate rate during the polishing work.

According to one embodiment of the present invention, a lubricant having an evaporation point of 150° C. or higher is added to the compound composition, and accordingly, the compound composition may remain on the surface of the vehicle protecting film even during polishing work, so that the surface of the vehicle protecting film can be prevented from being damaged.

According to one embodiment of the present invention, the compound composition includes an abrasive having a specific particle size so as to evenly polish the surface of the vehicle protecting film, so that the completion of the polishing work can be improved.

According to one embodiment of the present invention, a combination of a first lubricant having an oil evaporation point of 150° C. and a second lubricant having an oil evaporation point of 250° C. is added to the compound composition, so that the vehicle protecting film can be more effectively restored.

According to one embodiment of the present invention, the compound composition includes a second lubricant having an oil evaporation point of 200° C. or higher so as to be used stably even when being left in heat generated for a long time during the polishing work, so that the vehicle protecting film can be managed, such as polishing, without a damage on the surface.

The descriptions of the described embodiments are provided to enable any person having ordinary skill in the art to use or execute the present invention. It will be apparent to the person having ordinary skill in the art that various modifications are available for the embodiments, and general principles defined herein may be applied to other embodiments without departing from the scope of the present invention. Accordingly, the present invention will not be limited to the embodiments set forth herein but will be construed in the broadest scope consistent with the principles and novel features set forth herein.

What is claimed is:

1. A method for restoring a vehicle protecting film including a self-restoration layer having a damage on an upper side thereof, the method comprising:
a gloss solution step of applying a compound composition to the self-restoration layer of the vehicle protecting film and then polishing the upper side of the self-restoration layer by a predetermined thickness using a pad, thereby removing the damage; and
a coating solution step of applying a restoration coating composition on the upper side of the self-restoration layer from which damage is removed through the gloss solution step, thereby forming a restoration coating layer by a predetermined thickness, wherein
the gloss solution step and the coating solution step are performed, so that the vehicle protecting film is restored without separately replacing the vehicle protecting film.

2. The method of claim 1, wherein the gloss solution step includes polishing the upper side of the self-restoration layer by a thickness corresponding to a depth of the damage generated in the self-restoration layer or greater than a depth of the damage, and
the coating solution step includes applying the restoration coating composition as much as the thickness of the self-restoration layer polished through the gloss solution step.

3. The method of claim 1, wherein the gloss solution step includes:
a first compound polishing step of applying a first compound composition on an upper surface of the self-restoration layer, and polishing the upper surface by a thickness corresponding to the depth of the damage generated in to the upper surface or greater than the depth of the damage by using a first polishing pad; and
a second compound polishing step of applying a second compound composition to the upper surface polished through the first compound polishing step, and polishing the upper surface by using a second polishing pad, wherein
the first compound composition includes an abrasive having a larger particle size compared to the second compound composition.

4. The method of claim 3, wherein the first compound polishing step includes polishing the upper surface of the self-restoration layer by rotating the first polishing pad at 1500 rpm to 2000 rpm for 1 seconds to 30 seconds, and
the second compound polishing step includes polishing the upper surface of the self-restoration layer by rotating the second polishing pad at 600 rpm to 1000 rpm for 1 seconds to 30 seconds.

5. The method of claim 1, wherein the restoration coating composition includes:
a polar solvent including any one of acetone, isopropyl alcohol (IPA), methyl isobutyl ketone (MIBK), and ethyl acetate (EA);
a non-metallic material including any one of SiO₂ and polysilazane;
an additive including a first silicone, a second silicone, and a solvent; and
a non-polar solvent.

6. The method of claim 5, wherein the restoration coating composition includes:
10 wt % to 20 wt % of a polar solvent;
50 wt % to 70 wt % of a non-metallic material;
10 wt % to 50 wt % of an additive; and
5 wt % to 15 wt % of a non-polar solvent, based on a total weight.
